(19) United States
(12) Patent Application Publication
(10) Pub. No.: US 2020/0145566 A1
(43) Pub. Date: May 7, 2020

(54) IMAGE-PROCESSING APPARATUS AND LIGHT-FIELD IMAGING APPARATUS

(71) Applicant: OLYMPUS CORPORATION, Tokyo (JP)

(72) Inventors: Toshiro OKAMURA, Tokyo (JP); Yuki TOKUHASHI, Tokyo (JP); Satoshi WATANABE, Tokyo (JP); Shunichi KOGA, Tokyo (JP)

(73) Assignee: OLYMPUS CORPORATION, Tokyo (JP)

(21) Appl. No.: 16/736,890

(22) Filed: Jan. 8, 2020

Related U.S. Application Data
(63) Continuation of application No. PCT/JP2017/025590, filed on Jul. 13, 2017.

(51) Int. Cl. H04N 5/225; G02B 7/34; G06T 15/20

(52) U.S. Cl. CPC H04N 5/22541; G02B 7/34; G06T 2200/21; G06T 2207/10052; G06T 15/205

(57) ABSTRACT

An image-processing apparatus according to the present invention is provided with: a storing portion that stores a pupil-image function of an imaging optical system; and a reconstructing-processing portion that reconstructs, on the basis of the pupil-image function stored in the storing portion and input light-field images, a three-dimensional image of an imaging subject by means of repeated computations that give an initial value. The reconstructing-processing portion uses the three-dimensional image reconstructed on the basis of, among the light-field images of a plurality of frames acquired in a time series, the light field image of a preceding one of the frames in a time-axis direction as the initial value.

### CROSS-REFERENCE TO RELATED APPLICATIONS

This is a continuation of International Application PCT/JP2017/025590, with an international filing date of Jul. 13, 2017, which is hereby incorporated by reference herein in its entirety.

### TECHNICAL FIELD

The present invention relates to an image-processing apparatus and a light-field imaging apparatus.

### BACKGROUND ART

In the related art, there is a known light-field imaging apparatus: that is provided with an imaging device in which a plurality of pixels are two-dimensionally disposed and a microlens array having microlenses that are disposed, closer to an imaging subject than the imaging device is, in correspondence with each of the plurality of pixels of the imaging device; and that images a three-dimensional distribution of the imaging subject (for example, see Japanese Unexamined Patent Application, Publication No. 2010-102230).

Generally, unlike an image acquired by a normal imaging apparatus, an image acquired by a light-field imaging apparatus (hereinafter referred to as a light-field image) itself is an image in which images of numerous three-dimensionally distributed points overlap with each other; therefore, it is not possible to intuitively ascertain basic information such as plane position and distance of the imaging subject on a flat surface unless image processing is applied.

Therefore, the imaging subject is reconstructed by generating a three-dimensional image from the acquired light-field images and a pupil-image function of an imaging optical system that includes the microlenses. In processing for three-dimensionally reconstructing the imaging subject from the light-field images, a method in which optimization is achieved by performing repeated computations, by means of a computation method such as the Richardson-Lucy method, by using an appropriately set initial value is employed.

### SUMMARY OF INVENTION

An aspect of the present invention is an image-processing apparatus including: a storing portion that stores a pupil-image function of an imaging optical system; and a reconstructing-processing portion that reconstructs, on the basis of the pupil-image function stored in the storing portion and input light-field images, a three-dimensional image of an imaging subject by means of repeated computations that give an initial value, wherein the reconstructing-processing portion uses the three-dimensional image reconstructed on the basis of, among the light-field images of a plurality of frames acquired in a time series, the light-field image of a preceding one of the frames in a time-axis direction as the initial value.

Another aspect of the present invention is a light-field imaging apparatus including: an imaging optical system that focuses light coming from an imaging subject and forms an image of the imaging subject; a microlens array that has a plurality of microlenses that are two-dimensionally arrayed at a position at which a primary image is formed by the imaging optical system or a conjugate position with respect to the primary image and that focus light coming from the imaging optical system; an imaging device that has a plurality of pixels that receive the light focused by the microlenses and that generates light-field images by performing photoelectric conversion of the light received by the pixels; and any one of the above-described image-processing apparatuses that process the light-field images generated by the imaging.

### BRIEF DESCRIPTION OF DRAWINGS

FIG. 1 is a schematic diagram showing a light-field imaging apparatus according to a first embodiment of the present invention.

FIG. 2 is a block diagram showing an image-processing apparatus provided in the light-field imaging apparatus in FIG. 1.

FIG. 3 is a flowchart for explaining the operation of the image-processing apparatus in FIG. 1.

FIG. 4 is a flowchart for explaining three-dimensional reconstructing processing performed by the image-processing apparatus in FIG. 1.

FIG. 5 is a diagram showing examples of three-dimensional images calculated through a computation that is performed once by the image-processing apparatus in FIG. 1.

FIG. 6 is a diagram showing Reference Examples of three-dimensional images calculated through computations that are repeated 20 times at maximum by using an image created in a simple manner as an initial image.

FIG. 7 is a diagram showing Reference Examples of three-dimensional images calculated through computation that is performed once by using the same conditions as those used in FIG. 6.

FIG. 8 is a diagram showing examples of three-dimensional images calculated through the computations that are repeated ten times by the image-processing apparatus in FIG. 1.

FIG. 9 is a block diagram showing an image-processing apparatus according to a second embodiment of the present invention.

FIG. 10 is a graph showing examples of event evaluation values calculated by the image-processing apparatus in FIG. 9 for each frame.

FIG. 11 is a flowchart for explaining the operation of the image-processing apparatus in FIG. 9.

FIG. 12 is a flowchart for explaining a first modification of the three-dimensional reconstructing processing performed by the image-processing apparatus in FIG. 9.

FIG. 13 is a flowchart for explaining a second modification of the three-dimensional reconstructing processing performed by the image-processing apparatus in FIG. 9.

### DESCRIPTION OF EMBODIMENTS

### First Embodiment

An image-processing apparatus 2 and a light-field imaging apparatus 1 according to a first embodiment of the present invention will be described below with reference to the drawings.

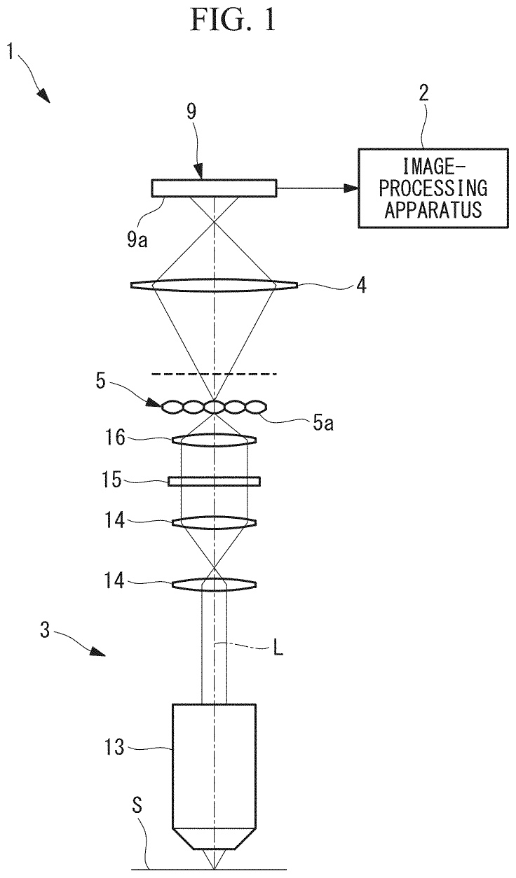

As shown in FIG. 1, the light-field imaging apparatus 1 according to this embodiment includes: an imaging optical system 3 that forms an image of an imaging subject S by focusing light coming from the imaging subject S (object point); a microlens array 5 that has a plurality of microlenses 5a that focus light coming from the imaging optical system 3; an imaging device 9 including a plurality of pixels 9a that receive light focused by the plurality of microlenses 5a and performs photoelectric conversion thereof; and the image-processing apparatus 2 according to this embodiment, which processes light-field images acquired by the imaging device 9. In the figure, reference sign 4 is a relay lens that relays the light-field images constructed by the microlens array 5 to an imaging surface of the imaging device 9. This component need not be the relay lens 4.

As shown in FIG. 1, the microlens array 5 is configured by two-dimensionally arraying the plurality of microlenses 5a having positive powers at the focal-point position of the imaging optical system 3 along a plane that is orthogonal to an optical axis L. These plurality of microlenses 5a are arrayed at a sufficiently large pitch as compared with the pixel pitch of the imaging device 9 (for example, a pitch that is eight times the pixel pitch of the imaging device 9).

The imaging device 9 is also configured by two-dimensionally arraying the individual pixels 9a in a direction that is orthogonal to the optical axis L of the imaging optical system 3. The plurality of pixels 9a are arrayed in each of regions corresponding to the plurality of microlenses 5a of the microlens array 5 (for example, in an 8×8 arrangement in the above-described example). The plurality of pixels 9a perform photoelectric conversion of the detected light, and output light-intensity signals (pixel values) that serve as light-field-image information of the imaging subject S.

The imaging device 9 sequentially outputs the light-field-image information about a plurality of frames acquired at different times in a time-axis direction. For example, the imaging device performs video recording or time-lapse recording.

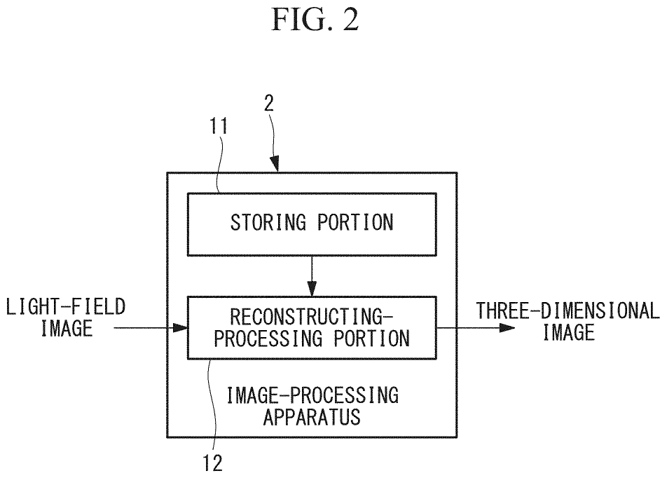

The image-processing apparatus 2 is configured by a processor, and includes, as shown in FIG. 2: a storing portion 11 that stores in advance pupil-image functions of the imaging optical system 3, the microlens array 5, and the relay lens 4; and a reconstructing-processing portion 12 that reconstructs a three-dimensional image of the imaging subject S on the basis of the pupil-image functions stored in the storing portion 11 and the input light-field images.

A pupil-image function [H] is a function that satisfies Expression (1) below:

[b]=[H][g] (1)

### Here,

[b] denotes a light-field image, and
[g] denotes the intensity of light coming from each portion of the three-dimensional imaging subject S.

In other words, Expression (1) indicates the relationship in which the light coming from the imaging subject S is converted to a light-field image via the imaging optical system 3 and received by the individual pixels 9a of the imaging device 9, and the pupil-image function [H] functions as a transformation matrix. It is possible to determine, in advance, the pupil-image functions of the imaging optical system 3, the microlens array 5, and the relay lens 4, and the pupil-image functions are stored in the storing portion 11.

The imaging optical system 3 includes, for example, as shown in FIG. 1: an objective lens 13, a pupil relay optical system 14, a phase plate 15, and an image-forming lens 16.

The reconstructing-processing portion 12 determines [g] that minimizes an error function e, expressed as Expression (2), when the light-field image [b] of Expression (1) is input.

$$\begin{matrix}\{ Eq . 1 \} & \\ e = \frac{{‖ Hg ( x , y , z , t ) - b ( x , y , t ) ‖}_{2}}{{‖ b ( x , y , t ) ‖}_{2}} & ( 2 )\end{matrix}$$

Here,

∥x∥₂ {Eq. 2}

is the L2 norm of x.

As a method for determining [g] that minimizes Expression (2), for example, repeated computations, such as computations according to the Richardson-Lucy method indicated in Eq. 3, are executed.

g^{(k+1)}=diag(H^{t}1)⁻¹ diag(H^{t} diag(Hg^{(k)})⁻¹b)g^{(k)} {Eq. 3}

Here,

g^{(k)} denotes the three-dimensional image of the imaging subject S that is calculated in k-th repeated computation,
b denotes the light-field image output from the imaging device 9,
diag denotes a diagonal matrix,
t denotes a transpose matrix,
−1 denotes an inverse, and
k denotes the number of repetitions.

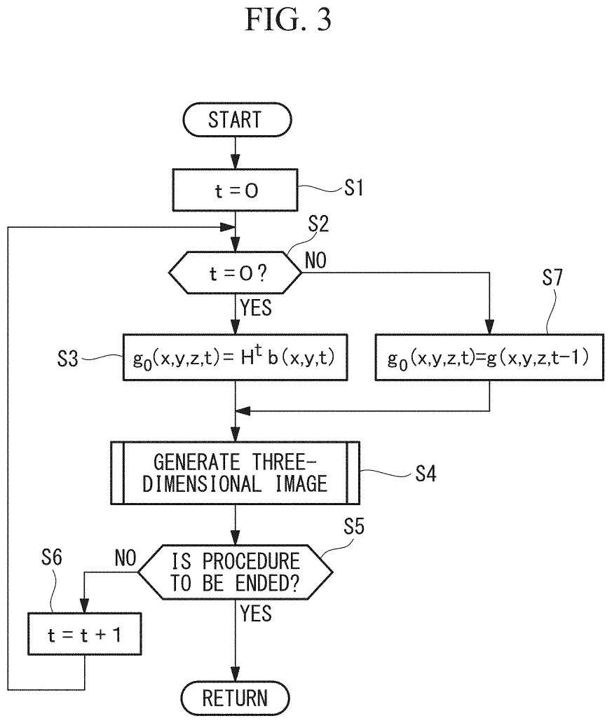

More specifically, as shown in FIG. 3, with the three-dimensional reconstructing processing performed by the reconstructing-processing portion 12, the frame number t is initialized to t=0, which indicates the first frame (step S1); whether or not t=0 is determined (step S2); and, in the case in which t=0, a light-field image acquired at t=0 is multiplied by the transpose matrix of the pupil-image function [H] so as to serve as an initial image (initial value) g₀ (x, y, z, t) given in the Richardson-Lucy method; and thus, an image that is created in a simple manner without being subjected to the repeated computations (step S3). Then, the Richardson-Lucy method is executed by employing this initial image g₀ (x, y, z, t), and a three-dimensional image based on the light-field image of the first frame is generated (step S4).

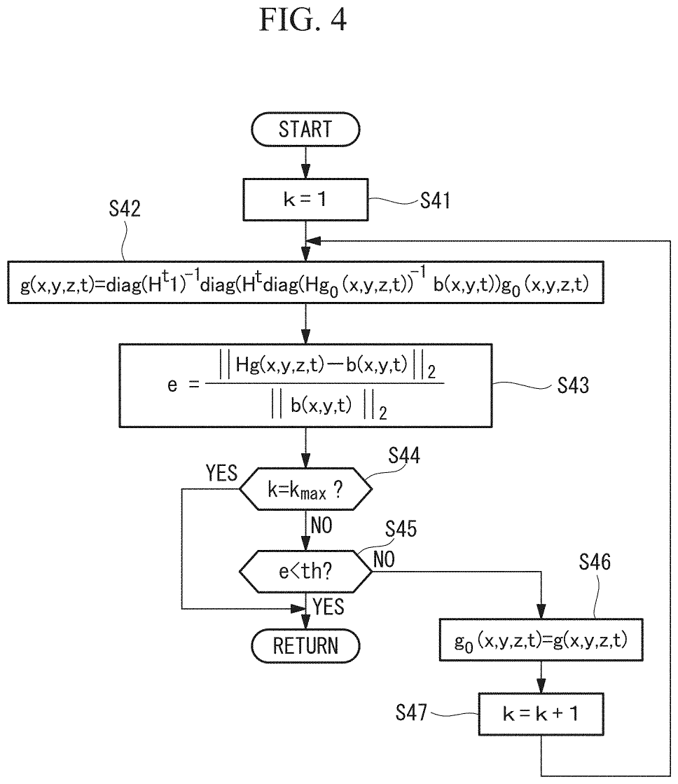

As shown in FIG. 4, in the three-dimensional-image generating processing according to the Richardson-Lucy method, the number of repetitions k is reset to k=1 (step S41), a three-dimensional image is generated by performing the computation of Eq. 3 by using the initial image g₀ (x, y, z, t) set in step S3 (step S42), and the error function e of Eq. 1 is calculated by using the generated three-dimensional image (step S43).

Then, whether or not the number of repetitions k is kₘₐₓ is determined (step S44); in the case in which k is kₘₐₓ, the processing is ended and the procedure advances to step S5; and, in the case in which k is not kₘₐₓ, whether or not the error function e is less than a predetermined threshold th is determined (step S45). Here, kₘₐₓ is a maximum value of the number of repetitions. The threshold th is a constant that varies according to the sizes of x, y, and z, and is experimentally determined.

In the case in which e<th, the repeated computations are ended, and, in the case in which e≥th, a computation result g (x, y, z, t) is input to the initial image g₀ (x, y, z, t) (step S46), the number of repetitions k is incremented (step S47), and the steps from step S42 are repeated.

Next, whether or not the frame number t is the final number or not is determined (step S5); in the case in which the frame number t is the final number, the procedure is ended; and, in the case in which the frame number t is not the final number, the frame number t is incremented (step S6), and the procedure returns to step S2.

In the second frame and thereafter, because t is determined not to be zero in step S2, the three-dimensional image g (x, y, z, t−1) calculated for the immediately preceding frame is set to the initial image g₀ (x, y, z, t) (step S7), and the steps from step S4 are repeated.

With the image-processing apparatus 2 and the light-field imaging apparatus 1 according to this embodiment, thus configured, because, regarding the second frame and thereafter, the repeated computations are performed by using the three-dimensional image g (x, y, z, t−1) generated by using the light-field image of the immediately preceding frame as the initial image g₀ (x, y, z, t), the number of repetitions k becomes one in nearly all cases when there is little change with respect to the light-field image of the immediately preceding frame, and thus, there is an advantage in that it is possible to considerably reduce the amount of time required to perform the three-dimensional reconstructing processing.

In the case in which there is a change with respect to the light-field image of the immediately preceding frame, because the error function e becomes equal to or greater than the threshold th, the repeated computations are performed within the range of the maximum value kₘₐₓ of the number of repetitions k, and thus, it is possible to generated an appropriate three-dimensional image g (x, y, z, t).

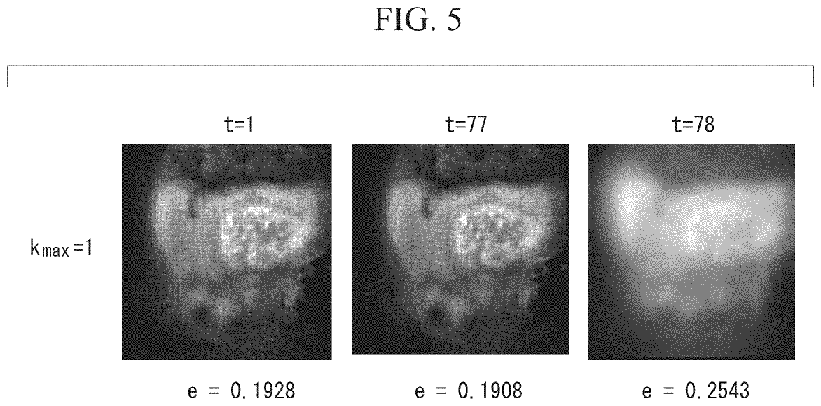

In FIG. 5, examples of the three-dimensional images generated at frame numbers t=1, 77, and 78 by setting the number of repetitions k to one.

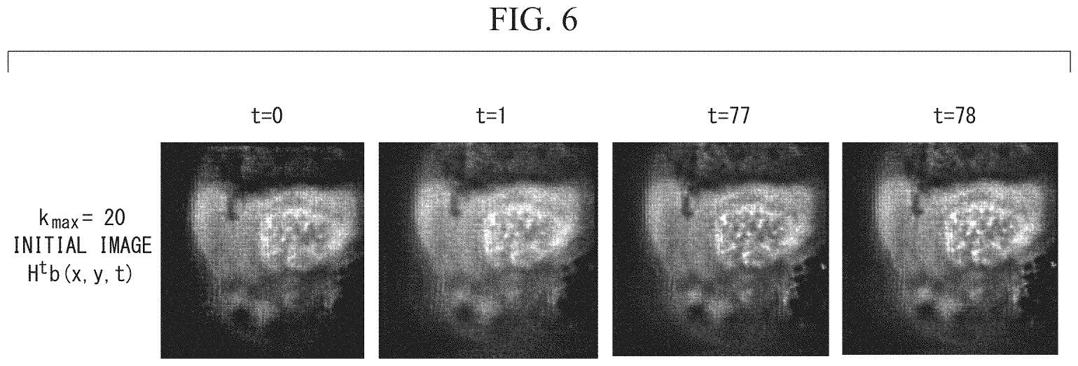

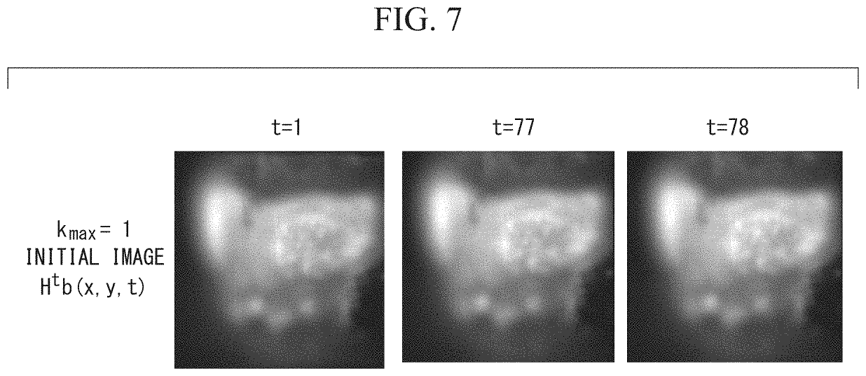

FIG. 6 shows a Reference Example of the case in which the repeated computations are performed by taking time until the error function e becomes less than the threshold by using the three-dimensional image g (x, y, z, t) created in a simple manner as the initial image g₀ (x, y, z, t), and FIG. 7 shows a Reference Example of the case in which the computations are performed with the same conditions while setting the number of repetitions k to one.

With the image-processing apparatus 2 and the light-field imaging apparatus 1 according to this embodiment, with regard to the cases in which the frame numbers t=1 and 77, it is possible to obtain, even if the number of repetitions k is set to one, three-dimensional images that are as clear as the three-dimensional images generated by taking time, shown in the Reference Example in FIG. 6, unlike the unclear three-dimensional images shown in the Reference Example in FIG. 7.

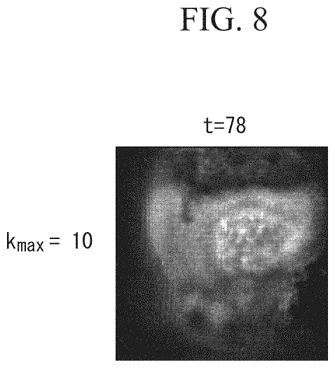

At the frame number t=78, although the three-dimensional image is unclear in the case in which the number of repetitions k is set to one, this is because some kind of change occurred with respect to the light-field image of the immediately preceding frame. In this case, for example, as shown in FIG. 8, by performing the repeated computations until the error function e becomes less than the threshold th by setting the maximum number of repetitions kₘₐₓ to 10, it is possible to obtain a clear three-dimensional image.

### Second Embodiment

Next, an image-processing apparatus 22 and a light-field imaging apparatus according to a second embodiment of the present invention will be described below with reference to the drawings.

In describing this embodiment, portions having the same configurations as those of the image-processing apparatus 2 and the light-field imaging apparatus 1 according to the first embodiment, described above, will be given the same reference signs, and descriptions thereof will be omitted.

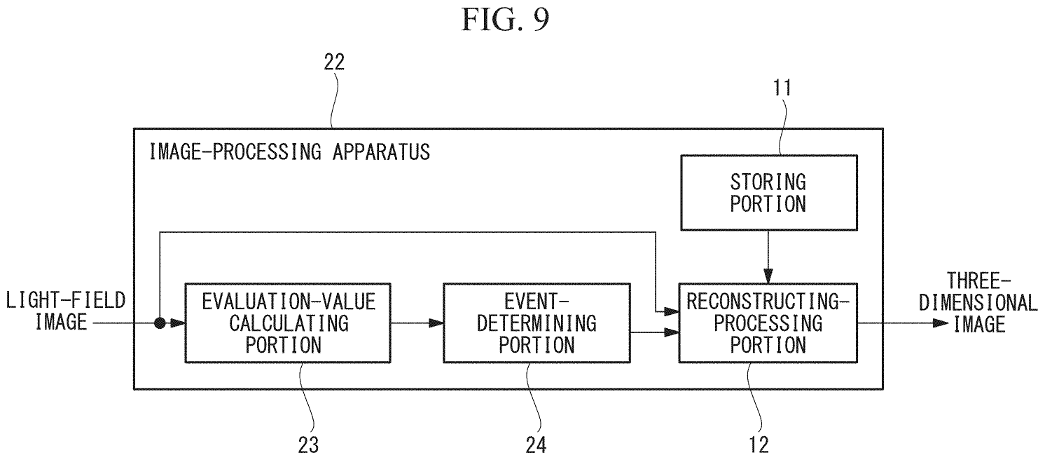

As shown in FIG. 9, the image-processing apparatus 22 according to this embodiment includes: an evaluation-value calculating portion 23 that calculates an event evaluation value based on the light-field images of a plurality of frames acquired by the imaging device 9 at a predetermined time interval; and an event-determining portion 24 that determines whether or not an event has occurred on the basis of the even evaluation value calculated by the evaluation-value calculating portion 23, and the reconstructing-processing portion 12 changes the initial image g₀ (x, y, z, t) by using the determination result of the event-determining portion 24.

The evaluation-value calculating portion 23 calculates an event evaluation value A(t) by means of Eq. 4 with respect to a t-th light-field image from the first light-field image in a sequence consisting of the light-field images of the plurality of frames acquired by the imaging device 9 at the predetermined time interval.

The event evaluation value A(t) is a representative value, for each light-field image, with respect to numerical values that indicate divergences from the average (predetermined reference value) of the entire sequence of the pixel values of the individual pixels included in the light-field images.

$$A ( t ) = {\sum }_{x , y} \vert b ( x , y , t ) - \frac{1}{{t}_{total}} {\sum }_{t} b ( x , y , t ) \vert \qquad \{ Eq . 4 \}$$

Here,

tₜₒₜₐₗ is the total number of frames.

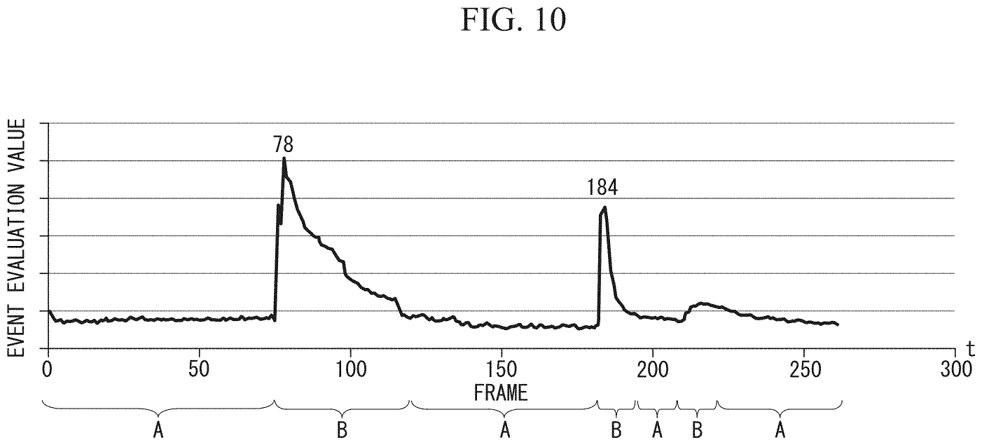

As a result of arraying, in time series, the calculated event evaluation values A(t) in association with the frames, the graph shown in FIG. 10 is obtained.

In FIG. 10, the event-determining portion 24 determines t=1 to t=77, t=117 to t=183, t=196 to t=209, and t=220 to t=270, where the event evaluation values A(t) are low, to be sections A (event not present), and the remaining t=78 to t=116, t=184 to t=195, and t=210 to t=219 where the event evaluation values A(t) are high, to be sections B (event present).

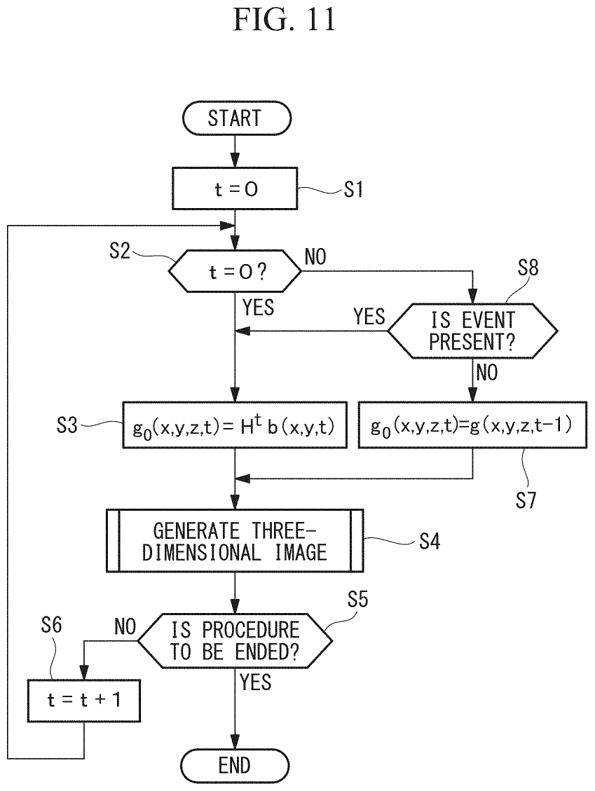

Specifically, as shown in FIG. 11, in the case in which it is determined that t is not zero in step S2, the event-determining portion 24 determines whether an event is present or not (step S8), and the reconstructing-processing portion 12 sets the initial image g₀ (x, y, z, t) via step S3 in the case in which it is determined that an event is present, and sets the initial image g₀ (x, y, z, t) via step S7 in the case in which it is determined that an event is not present.

With the image-processing apparatus 22 and the light-field imaging apparatus according to this embodiment, thus configured, whether or not an event is present in an light-field image is determined, and in the case in which it is determined that an event is not present, because the three-dimensional image g (x, y, z, t−1) calculated for the immediately preceding frame is set to the initial image g₀ (x, y, z, t) and the three-dimensional image g (x, y, z, t) is generated, the number of repetitions k becomes one in nearly all cases, and thus, there is an advantage in that it is possible to considerably reduce the amount of time required to perform the three-dimensional reconstructing processing.

In the case in which it is determined that an event is present, by using, as the initial image g₀ (x, y, z, t), an image that is constructed in a simple manner from the light-field image, it is possible to reduce the value of the error function e with a number of repetitions k that is less than that for the three-dimensional image g (x, y, z, t−1) for the immediately preceding frame, and, in this case also, there is an advantage in that it is possible to reduce the amount of time required for performing the three-dimensional reconstructing processing.

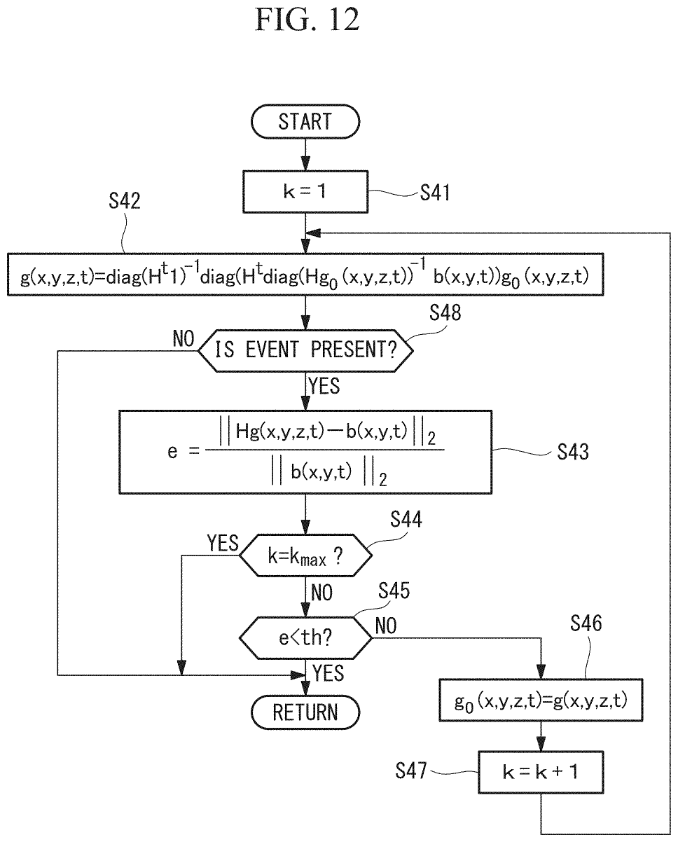

In this embodiment, although the initial image g₀ (x, y, z, t) is changed depending on the presence/absence of an event, in addition to this, the processing performed by the reconstructing-processing portion 12 may be changed, as shown in FIG. 12. In this case, whether or not an event is present may be determined (step S48) after executing step S42, and, in the case in which an event is not present, the processing may be ended before step S43 in which the error function e is calculated and the three-dimensional image g (x, y, z, t) calculated in the first computation may be output, and, in the case in which an event is present, the steps from step S43 may be executed.

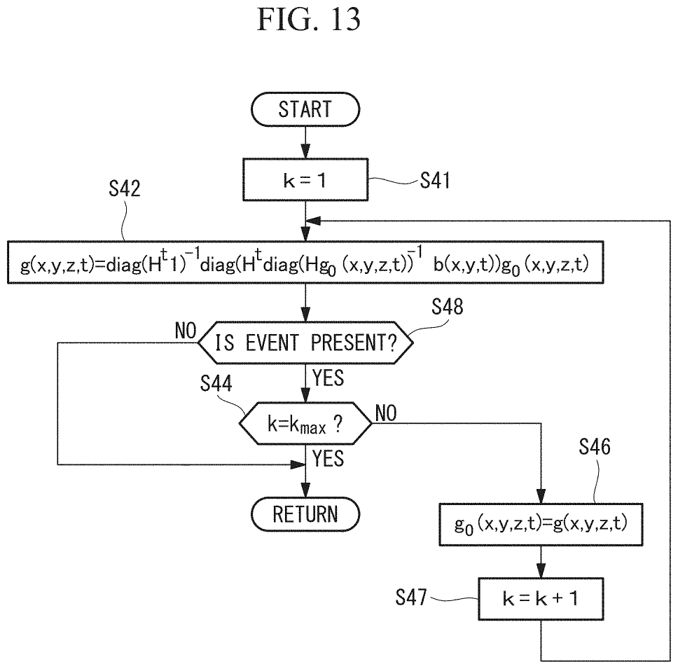

As shown in FIG. 13, in step S48, in the case in which an event is present, instead of calculation of the error function e and determination of the threshold th of the error function e (step S45), the repeated computations may be automatically performed for a number of repetitions (first number of repetitions) k set in advance, for example, kₘₐₓ=10. In this case, in the case in which an event is absent, a number of repetitions (second number of repetitions) k becomes one which is less than the first number of repetitions k. The number of repetitions k may be set to be an appropriate value by means of an experiment. The second number of repetitions k may also be equal to or greater than two.

In this embodiment, although the event evaluation value A(t) is calculated by using pixel values of the average image of the entire sequence, as indicated in Eq. 5, the event evaluation value A(t) may be a sum of absolute values, taken for the entire light-field images, with respect to differences between pixel values of corresponding pixels in the light-field images that are adjacent (immediately preceding) in the time-axis direction. In this case, the presence/absence of an event is determined depending on whether or not the absolute values of the differences exceed a predetermined threshold.

$$A ( t ) = {\sum }_{x , y} \vert b ( x , y , t ) - b ( x , y , t - 1 ) \vert \qquad \{ Eq . 5 \}$$

Obtaining the differences is suitable for ascertaining movements of and changes in the shape of the imaging subject S. Because it is not necessary to acquire all of the light-field images, there is an advantage in that it is possible to detect the event evaluation value A(t) substantially in real time while imaging.

In this embodiment, although the value in which, with respect to the individual pixels of the light-field images of the individual frames, the absolute values of the difference values indicating the divergences from the reference value are added up for the entire sequence is used as the event evaluation value A(t), alternatively, another arbitrary representative value, for example, an arbitrary statistical value such as an average, a maximum value, a minimum value, or a median, may be employed as the event information.

Although this embodiment has been described in terms of an example in which a three-dimensional image g (x, y, z, t−1) is generated by using the light-field image of an immediately preceding frame, alternatively, the three-dimensional image g (x, y, z, t−1) may be generated by using the light-field image of a preceding frame in the time-axis direction.

Although this embodiment has been described in terms of an example in which the pixels 9a of the imaging device 9 and the pixels on the light-field image to be used in event detection coincide with each other, alternatively, the pixels 9a of the imaging device 9 and the pixels on the light-field image need not coincide with each other.

In an actual optical system, there are cases in which a setting error occurs, such as the pitch of the microlens 5a not being an integer multiple of the pixel pitch and the microlenses 5a being disposed in a slightly rotated manner, and thus, there are cases in which calibrating processing is performed, wherein the pixels are rearranged by means of interpolating processing at the beginning of the image processing. In this case, strictly speaking, the pixels 9a of the imaging device 9 and the pixels on the light-field image to be used in event detection do not coincide with each other.

As a result, the following aspect is read from the above described embodiment of the present invention.

An aspect of the present invention is an image-processing apparatus including: a storing portion that stores a pupil-image function of an imaging optical system; and a reconstructing-processing portion that reconstructs, on the basis of the pupil-image function stored in the storing portion and input light-field images, a three-dimensional image of an imaging subject by means of repeated computations that give an initial value, wherein the reconstructing-processing portion uses the three-dimensional image reconstructed on the basis of, among the light-field images of a plurality of frames acquired in a time series, the light-field image of a preceding one of the frames in a time-axis direction as the initial value.

With this aspect, as a result of the reconstructing-processing portion performing the repeated computations that give the initial value on the basis of the pupil-image function of the imaging optical system stored in the storing portion and the input light-field images, the three-dimensional image of the imaging subject is reconstructed. In the case in which an event indicating some kind of change between the light-field images of adjacent frames is not so significant, the three-dimensional image, which is reconstructed by using the light-field images of the plurality of frames acquired in a time series, does not have a large difference with respect to the three-dimensional image reconstructed by using the individual light-field images preceding in the time-axis direction. Therefore, by using, as the initial value, the three-dimensional image reconstructed on the basis of the light-field image of the preceding frame in the time-axis direction, it is possible to cause the repeated computations to be completed earlier, and thus, it is possible to perform the three-dimensional reconstructing processing in a short period of time.

In the above-described aspect, the reconstructing-processing portion may use, as the initial value, the three-dimensional image reconstructed on the basis of the light-field image of an immediately preceding one of the frames.

The above-described aspect may further include an event-determining portion that determines the presence/absence of an event in the light-field images wherein, the reconstructing-processing portion may use, as the initial value, the three-dimensional image reconstructed on the basis of the light-field image of the immediately preceding one of the frames in the case in which the event-determining portion determines that the event is not present in the light-field image.

By doing so, in the case in which the event-determining portion determines that the event is not present, by using, as the initial value, the three-dimensional image reconstructed by using the preceding light-field image in the time-axis direction, which has no large difference with respect to the three-dimensional image obtained as a result of the reconstructing processing, it is possible to cause the repeated computations to be completed earlier, and thus, it is possible to perform the three-dimensional reconstructing processing in a short period of time.

In the above-described aspect, the event-determining portion may determine that the event is present in the case in which a difference between the light-field image to be used in reconstruction and the light-image field image of the immediately preceding one of the frames exceeds a predetermined threshold.

By doing so, it is possible to determine that the event is present in a simple manner in the case in which the difference between the light-field image to be used in reconstruction and the light-field image of the preceding frame in the time-axis direction exceeds the predetermined threshold.

In the above-described aspect, the reconstructing-processing portion may use, as an initial image, an image created from the light-field image to be used in reconstruction without being subjected to repeated computation in the case in which the event-determining portion determines that the event is present.

By doing so, regarding the light-field image in which it is determined that the event is present, it is possible to use the image created from said light-field image without being subjected to the repeated computations as the initial image, and, in the case in which it is determined that the event is not present, it is possible to switch to the processing in which the three-dimensional image reconstructed by using the preceding light-field image in the time-axis direction is used as the initial value.

In the above-described aspect, the reconstructing-processing portion may perform the repeated computations according to a first number of repetitions set in advance, in the case in which the event-determining portion determines that the event is present, and may perform the repeated computations according to a second number of repetitions that is less than the first number of repetitions, in the case in which the event-determining portion determines that that the event is not present.

By doing so, it is possible to keep the number of repetitions low in the case in which it is determined that the event is not present, and it is possible to perform the three-dimensional reconstructing processing in a short period of time.

In the above-described aspect, the repeated computations that give the initial value may be performed in accordance with the Richardson-Lucy method.

Another aspect of the present invention is a light-field imaging apparatus including: an imaging optical system that focuses light coming from an imaging subject and forms an image of the imaging subject; a microlens array that has a plurality of microlenses that are two-dimensionally arrayed at a position at which a primary image is formed by the imaging optical system or a conjugate position with respect to the primary image and that focus light coming from the imaging optical system; an imaging device that has a plurality of pixels that receive the light focused by the microlenses and that generates light-field images by performing photoelectric conversion of the light received by the pixels; and any one of the above-described image-processing apparatuses that process the light-field images generated by the imaging.

### REFERENCE SIGNS LIST

1 light-field imaging apparatus
2 image-processing apparatus
3 imaging optical system
5 microlens array
5a microlens
9 imaging device
9a pixel
11 storing portion
12 reconstructing-processing portion
24 event-determining portion
S imaging subject

1. An image-processing apparatus comprising:
one or more processors,
the one or more processors are configured to execute:
storing step for storing a pupil-image function of an imaging optical system; and
reconstructing-processing step for reconstructing, on the basis of the stored pupil-image function and input light-field images, a three-dimensional image of an imaging subject by means of repeated computations that give an initial value,
wherein in the reconstructing-processing step, the three-dimensional image reconstructed on the basis of, among the light-field images of a plurality of frames acquired in a time series, the light-field image of a preceding one of the frames in a time-axis direction is used as the initial value.

2. The image-processing apparatus according to claim 1, wherein in the reconstructing-processing step, the three-dimensional image reconstructed on the basis of the light-field image of an immediately preceding one of the frames is used as the initial value.

3. The image-processing apparatus according to claim 1, wherein the one or more processors are further configured to execute:
an event-determining step for determining the presence/absence of an event in the light-field images,
wherein in the reconstructing-processing step, the three-dimensional image reconstructed on the basis of the light-field image of the immediately preceding one of the frames is used as the initial value when the event-determining step determines that the event is not present in the light-field image.

4. The image-processing apparatus according to claim 3, wherein the event-determining step determines that the event is present when a difference between the light-field image to be used in reconstruction and the light-image field image of the immediately preceding one of the frames exceeds a predetermined threshold.

5. The image-processing apparatus according to claim 4, wherein the reconstructing-processing step uses, as an initial image, an image created from the light-field image to be used in reconstruction without being subjected to repeated computation when the event-determining step determines that the event is present.

6. The image-processing apparatus according to claim 3, wherein in the reconstructing-processing step, the repeated computations is performed according to a first number of repetitions set in advance, when the event-determining step determines that the event is present, and the repeated computations is performed according to a second number of repetitions that is less than the first number of repetitions, when the event-determining step determines that that the event is not present.

7. The image-processing apparatus according to claim 1, wherein the repeated computations that give the initial value are performed in accordance with the Richardson-Lucy method.

8. The light-field imaging apparatus comprising:
an imaging optical system that is configured to focus light coming from an imaging subject and forms an image of the imaging subject;
a microlens array that has a plurality of microlenses that are two-dimensionally arrayed at a position at which a primary image is formed by the imaging optical system or a conjugate position with respect to the primary image and that is configured to focus light coming from the imaging optical system;
an imaging device that has a plurality of pixels that receive the light focused by the microlenses and that is configured to generate light-field images by performing photoelectric conversion of the light received by the pixels; and
an image-processing apparatus according to claim 1 that is configured to process the light-field images generated by the imaging device.
